(19) United States
(12) Patent Application Publication
(10) Pub. No.: US 2020/0240560 A1
(43) Pub. Date: Jul. 30, 2020

(54) VACUUM BELLOWS THRUST INHIBITOR FOR CLAW CLAMPED FLANGES

(71) Applicant: BEIJING APOLLO DING RONG SOLAR TECHNOLOGY CO., LTD., Beijing (CN)

(72) Inventors: Cormac WICKLOW, San Jose, CA (US); Matthew SHEFFIELD, San Ramon, CA (US)

(21) Appl. No.: 16/261,893

(22) Filed: Jan. 30, 2019

(51) Int. Cl. F16L 27/11; F16F 15/02; F04B 53/00; F16B 7/06

(52) U.S. Cl. CPC F16L 27/11; F16F 15/022; F04B 53/003; F16F 2234/02; F16F 2228/08; F16F 2230/0005; F16B 7/06

(57) ABSTRACT

According to an aspect of the present disclosure, a thrust inhibitor device for use with a vacuum bellows includes a pair of thrust blocks each including a body and a shaft, in which the pair of thrust blocks are configured to engage opposed flanges of the vacuum bellows, and a turnbuckle having a pair of axial holes each connected to one of the shafts. A length between opposing ends of the pair of thrust blocks is adjustable to control a deflection of the vacuum bellows.

### FIELD

The present disclosure is directed to vacuum bellows components, such as thrust inhibitors for use with vacuum bellows.

### BACKGROUND

Bellows are a key component in isolating vibrating machinery from fixed equipment, such as in evacuation (i.e., vacuum) applications between vibrating machinery and fixed equipment. A bellows may act like a piston and a spring. As a piston, the bellows converts changes in internal or external pressure into an applied force. As a spring, the bellows reacts elastically to an applied force (e.g., vibration) and exerts a reactive force. In a conventional evacuation application, a bellows is positioned between a vacuum pump and fixed equipment to maintain a vacuum while accommodating differential movement between the fixed equipment and the vacuum pump. Differential air pressure forces acting on the bellows may cause the bellows to compress, deflect, or become unsealed from the vacuum pump and the fixed equipment. Vibration forces shaking the bellows could separate the bellows from either the vacuum pump or the fixed equipment.

### SUMMARY

According to an aspect of the present disclosure, a thrust inhibitor device for use with a vacuum bellows includes a pair of thrust blocks each including a body and a shaft, wherein the pair of thrust blocks are configured to engage opposed flanges of the vacuum bellows, and a turnbuckle having a pair of axial holes each connected to one of the shafts. A length between opposing ends of the pair of thrust blocks is adjustable to control a deflection of the vacuum bellows.

According to an aspect of the present disclosure, a thrust inhibitor device and vacuum bellows assembly includes a vacuum bellows, a pair of thrust blocks each including a body and a shaft, wherein the pair of thrust blocks engage opposed flanges of the vacuum bellows; and a turnbuckle having a pair of axial holes each connected to one of the shafts. A length between opposing ends of the pair of thrust blocks is adjustable to control a deflection of the vacuum bellows.

### BRIEF DESCRIPTION OF THE DRAWINGS

FIG. 1 is a perspective view of a vacuum pump assembly according to an embodiment of the present disclosure.

FIG. 2 is a cross sectional view of the interface between the thrust inhibitor and a vacuum bellows according to an embodiment of the present disclosure.

FIG. 3 is a perspective view of a thrust inhibitor of the vacuum pump assembly according to an embodiment of the present disclosure.

FIG. 4 is a cross sectional view of the thrust inhibitor according to an embodiment of the present disclosure.

### DETAILED DESCRIPTION

The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure. As used herein, a first element located “on” a second element can be located on the exterior side of a surface of the second element or on the interior side of the second element. As used herein, a first element is located “directly on” a second element if there exist a direct physical contact between a surface of the first element and a surface of the second element. As used herein, an element is “configured” to perform a function if the structural components of the element are inherently capable of performing the function due to the physical and/or electrical characteristics thereof.

The present inventors realized that there is a need to develop an easy to install and adjust an inhibitor to mitigate deflections and vibrations of the bellows evacuation applications.

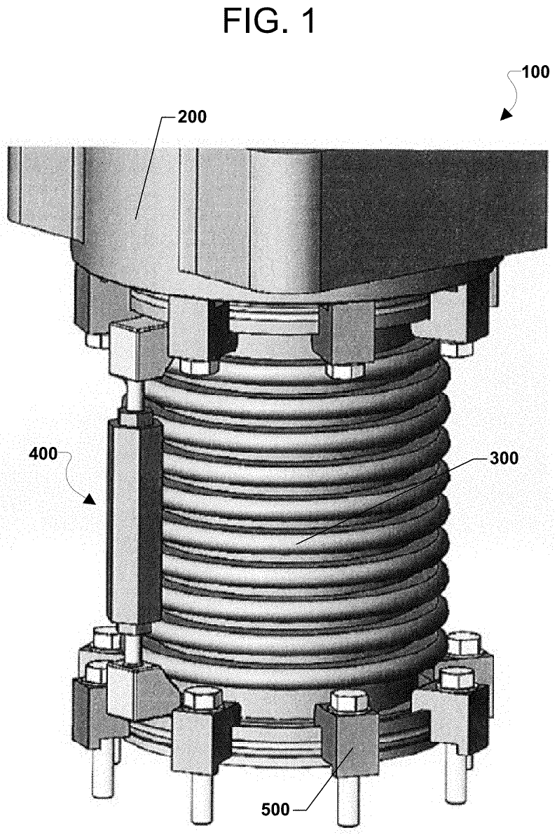

FIG. 1 illustrates a perspective view of a vacuum pump assembly 100. The vacuum pump assembly 100 may include a vacuum pump 200, a bellows 300, an inhibitor 400 according to some embodiments, and a plurality of claw clamps 500. The bellows 300 may be a key component in isolating vibrating machinery from fixed equipment, particularly in evacuation applications between vibrating machinery (i.e., the vacuum pump 200) and fixed equipment (not shown) attached by the claw clamps 500. The plurality of claw clamps 500 may secure both the vacuum pump 200 and fixed equipment (not shown) to flanges on the bellows 300.

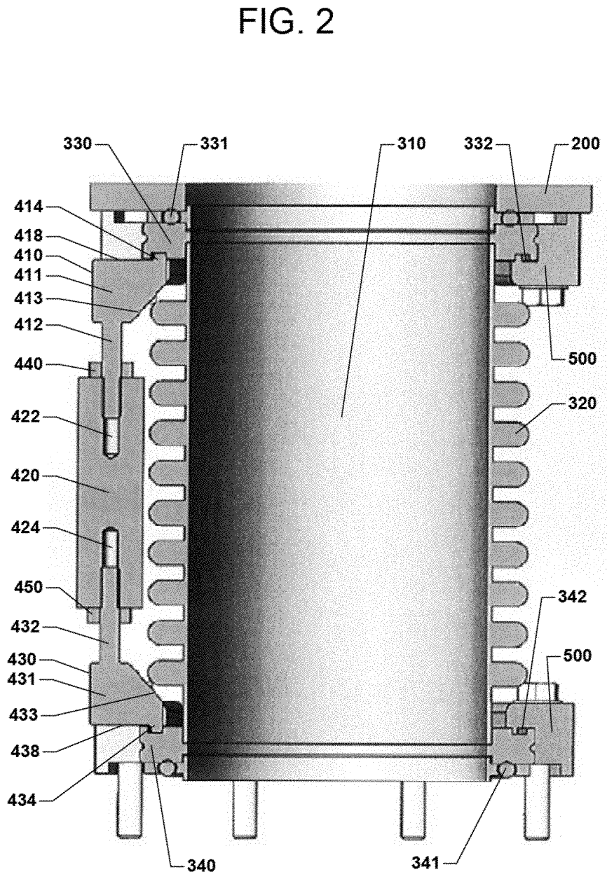

The flanges 330, 340 on the bellows 300 are illustrated in FIG. 2, which is a cross sectional view of the interface between the thrust inhibitor and a vacuum bellows, according to an embodiment. The flanges 330, 340 on the bellows 300 are opposed to each other and located at opposite ends of the bellows 300. The flanges 330, 340 may be utilized for mounting the bellows 300 to a vacuum pump 200 at one end, and to fixed equipment at the other end. The bellows 300 is configured to expand and contract to accommodate the vibration and differential air pressure forces acting on the bellows that may cause the bellows to compress or deflect.

In an industrial setting, cantilevered vacuum tubing i.e., the bellows 300, may extend between the vacuum pump 200 and fixed equipment (not shown) that requires a negative pressure (i.e., vacuum) environment. As the vacuum pump 200 begins to operate, the bellows 300 may undergo a large load due to differential air pressure forces acting on the inside surface of the bellows 320 and on the outside surface of the outer perimeter of the bellows 310. These differential forces may cause the bellows 300 to compress or deflect. If such deflections are not limited, the bellows 300 could become unsealed from the vacuum pump 200 and/or the fixed equipment. Additionally, vibration forces from the operation of the vacuum pump 200 may shake the bellows loose from the vacuum pump and the fixed equipment if such forces are not resisted. The thrust inhibitor 400 allows for a variable height to be set for the bellows 300 so that as the vacuum pump 200 begins to create differential forces, the thrust inhibitor 400 prevents compression of the bellows 300 and absorbs some of the differential forces that would otherwise compress, deflect, or unseal the bellows 300.

The thrust inhibitor 400 is an improvement over solid rods that traditionally have been attached or fixed to flange extensions on conventional metal bellows. For example, the variable height of the thrust inhibitor 400 may be easily adjusted by hand or a tool to customize the amount of deflection permitted for the bellows 300. Numerous thrust inhibitors 400 may be added and their heights adjusted to customize the direction of deflection of the bellows 300 i.e., its bend. When finally adjusted, the thrust inhibitor 400 may be easily fixed into position by lock nuts. The thrust inhibitor 400 may be placed directly onto particular industry standard flange sizes that maintain flange grooves for securing the flanges. These features are not available with conventional metal bellows.

FIG. 2 illustrates that the flanges 330, 340 of the bellows 300 may include flange grooves 332, 342 and O-rings 331, 341. The O-rings 331, 341 may allow for an airtight seal between the bellows 300 and the vacuum pump 200 and between the bellows 300 and the fixed equipment (not shown), when the claw clamps 500 are tightened into the flange grooves 332, 342. With the bellows 300 mounted to the vacuum pump 200 and the fixed equipment by the claw clamps 500 pressing down into the flange grooves 332, 342, the vibration and differential air pressure forces acting on the bellows 300 may be inhibited/mitigated by attachment of a thrust inhibitor 400.

FIG. 2 illustrates that the thrust inhibitor 400 may be positioned outside of and parallel to the outer diameter of the bellows 300. FIG. 2 shows one thrust inhibitor 400 attached to the flanges 330, 340, but a plurality of thrust inhibitors may be attached to the remaining periphery of the flanges 330, 340.

The thrust inhibitor 400 may include a pair of thrust blocks 410, 430 having a body 411, 431 and a shaft 412, 432. The pair of thrust blocks 410, 430 may be configured to engage opposed flanges 330, 340 of the bellows 300. A turnbuckle 420 having axial holes 422, 424 may be connected to one of the shafts 412, 432 of the thrust blocks 410, 430.

The overall length of the thrust inhibitor 400 may be adjusted by rotating the turnbuckle 420 clock-wise or counter-clock-wise, thereby controlling a deflection of the bellows 300. To facilitate changing the overall length of the thrust inhibitor 400, one set of the connecting axial holes 422 and shafts 412 in the turnbuckle 420 may have right-hand threads, while the opposing set of connecting axial holes 424 and shafts 432 may have left-hand threads so that as the turnbuckle 420 rotates clock-wise or counter-clock-wise, the overall length increases or decreases.

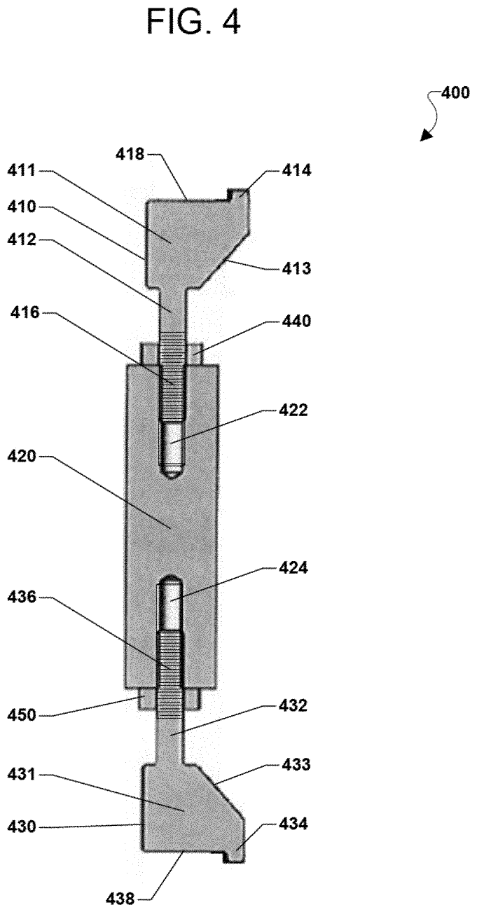

The thrust inhibitor 400 may also include lock nuts 440, 450 positioned on one of the shafts 412, 432 between the body 411, 431 and the turnbuckle 420. The lock nuts 440, 450 may have internal threads matching the external threads 416, 436, illustrated in FIG. 4, for the shafts 412, 432 so that each lock nut may be tightened against the turnbuckle 420. Once the lock nuts are tightened against the turnbuckle 420, the turnbuckle may be unable to be moved clock-wise or counter-clock-wise until the lock nuts are loosened.

FIG. 2 shows that each body 411, 431 of the pair of the thrust blocks 410, 430 includes a foot surface 418, 438, a ramped surface 413, 433, and a claw 414, 434. These features of the body of the thrust blocks 410, 430 may be configured to engage with particular features of the bellows 300. For example, the foot surface 418, 438 may be configured to engage the flange 330, 340 of the bellows 300. The claw 418, 438 may be configured to engage the flange groove 332, 342 in the flange 330, 340 of the bellows 300. The ramped surface 413, 433 may be configured to avoid contact with the outside surface of the outer perimeter of the bellows 310.

As illustrated in FIG. 2, the thrust inhibitor 400 may be positioned and attached on the periphery of the flanges 330, 340. The claws 414, 434 may be inserted into the flange grooves 332, 342 to loosely hold the thrust inhibitor 400 in position. The ramp surface 413, 433 of the thrust block 410, 430 may be configured to slope away from the claws 414, 434 toward the shafts 412, 432 avoiding the outside surface of the outer perimeter of the bellows 310. The configuration may facilitate quick insertion of the claws 414, 434 and positioning of the thrust inhibitor 400.

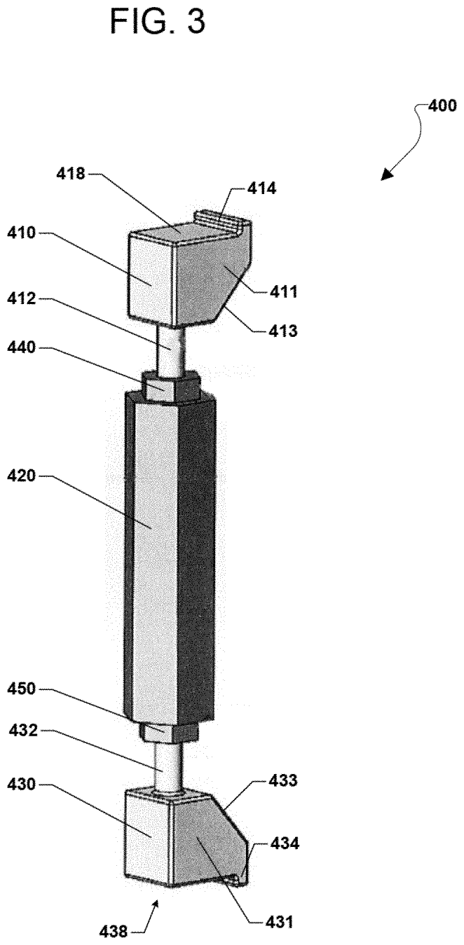

The turnbuckle 420 may be rotated, manually or by a tool, to adjust the overall length of the thrust inhibitor 400 and until the foot surfaces 418, 438 of the thrust blocks 410, 430 fully engage the flanges 330, 340. Once the overall length of thrust inhibitor 400 is set, the turnbuckle 420 may be locked into position by tightening, manually or by a tool, the lock nuts 440, 450 against the axial ends of the turnbuckle 420. The turnbuckle 420 may have an outer perimeter shape including a triangle, square, pentagon, hexagon, octagon, circle, or other polygon for tightening by hand or by a tool. FIG. 3 is an embodiment showing a hexagonal outer perimeter shape for the turnbuckle 420. When locked into position as shown in FIG. 2, the thrust inhibitor 400 may be removed or re-positioned along the periphery of the flanges 330, 340. Additional thrust inhibitors also may be positioned and attached as described.

The plurality of thrust inhibitors 400 may be positioned around the periphery of the flanges 330, 340 of the bellows 300 and configured to allow the bellows 300 to bend or deflect in a certain direction. Deflection of the bellows 300 may mitigate vibration and differential air pressure forces that act on the bellows 300. The flanges 330, 340 may be configured in a range of flange sizes and types, but the flanges may particularly be Industrial Organization for Standardization (ISO) flanges ranging from reference numbers NW63 to NW100.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A thrust inhibitor device for use with a vacuum bellows, comprising:
a pair of thrust blocks each including a body and a shaft, wherein the pair of thrust blocks are configured to engage opposed flanges of the vacuum bellows; and
a turnbuckle having a pair of axial holes each connected to one of the shafts,
wherein a length between opposing ends of the pair of thrust blocks is adjustable to control a deflection of the vacuum bellows.

2. The thrust inhibitor of claim 1, wherein a first axial hole in the turnbuckle has right-hand threads, and a second axial hole in the turnbuckle has left-hand threads, wherein the shaft of a first thrust block has right-hand threads, and the shaft of a second thrust block has left-hand threads.

3. The thrust inhibitor of claim 2, further comprising a pair of lock nuts each positioned on one of the shafts between the body and the turnbuckle.

4. The thrust inhibitor of claim 3, wherein a first lock nut has right-hand threads, and a second lock nut has left-hand threads, each lock nut configured to be tightened against the turnbuckle.

5. The thrust inhibitor of claim 1, wherein each body of the pair of the thrust blocks includes a foot surface, a ramped surface, and a claw.

6. The thrust inhibitor of claim 5, wherein:
the foot surface is configured to engage one of the flanges of the vacuum bellows, and the claws is configured to engage a flange groove in one of the flanges of the vacuum bellows, and
the ramped surface is configured to avoid contact with the vacuum bellows.

7. The thrust inhibitor of claim 6, wherein the foot surface is configured to engage the flange when the vacuum bellows is compressing.

8. The thrust inhibitor of claim 7, wherein the foot surface is configured to engage flanges that are Industrial Organization for Standardization (ISO) flanges ranging from reference numbers NW63 to NW100.

9. The thrust inhibitor of claim 6, wherein the thrust inhibitor is configured to be positioned around the perimeter of the bellows and configured to allow the vacuum bellows to bend in a certain direction.

10. The thrust inhibitor of claim 1, wherein the turnbuckle has an outer perimeter shape of one of a triangle, square, pentagon, hexagon, octagon, or circle.

11. The thrust inhibitor of claim 10, wherein the turnbuckle is configured to be manually tightened.

12. A thrust inhibitor device and vacuum bellows assembly, comprising:
a vacuum bellows;
a pair of thrust blocks each including a body and a shaft, wherein the pair of thrust blocks engage opposed flanges of the vacuum bellows; and
a turnbuckle having a pair of axial holes each connected to one of the shafts,
wherein a length between opposing ends of the pair of thrust blocks is adjustable to control a deflection of the vacuum bellows.

13. The assembly of claim 12, wherein a first axial hole in the turnbuckle has right-hand threads, and a second axial hole in the turnbuckle has left-hand threads, wherein the shaft of a first thrust block has right-hand threads, and the shaft of a second thrust block has left-hand threads.

14. The assembly of claim 13, further comprising a pair of lock nuts each positioned on one of the shafts between the body and the turnbuckle, wherein a first lock nut has right-hand threads, and a second lock nut has left-hand threads, each lock nut configured to be tightened against the turnbuckle.

15. The assembly of claim 12, wherein each body of the pair of the thrust blocks includes a foot surface, a ramped surface, and a claw.

16. The assembly of claim 15, wherein:
the foot surface engages one of the flanges of the vacuum bellows, and the claws engages a flange groove in one of the flanges of the vacuum bellows, and
the ramped surface avoids contact with the vacuum bellows.

17. The assembly of claim 16, wherein the foot surface engages the flange when the vacuum bellows is compressing.

18. The assembly of claim 17, wherein the foot surface engages flanges that are Industrial Organization for Standardization (ISO) flanges ranging from reference numbers NW63 to NW100.

19. The assembly of claim 16, wherein the thrust inhibitor is positioned around the perimeter of the bellows and allows the vacuum bellows to bend in a certain direction.

20. The assembly of claim 12, wherein the turnbuckle has an outer perimeter shape of one of a triangle, square, pentagon, hexagon, octagon, or circle, and wherein the turnbuckle is configured to be manually tightened.
